(19) United States
(12) Patent Application Publication
(10) Pub. No.: US 2005/0169498 A1
(43) Pub. Date: Aug. 4, 2005

(54) Apparatus and method for watermarking digital image

(75) Inventors: Yung-lim Choi, Seongnam-si (KR); Ji-young Moon, Suwon-si (KR); Sang-su Choi, Bucheon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/047,664

(22) Filed: Feb. 2, 2005

(30) Foreign Application Priority Data
Feb. 2, 2004 (KR) 10-2004-0006595

(51) Int. Cl. G06K 9/00

(52) U.S. Cl. 382/100

(57) ABSTRACT

A watermarking apparatus for embedding a watermark in a digital image, an apparatus for extracting watermark information from a watermarked image using a public key having a plurality of secret keys, and an apparatus for identifying whether a watermarked image generated by embedding a watermark in each region using a unit secret key is a copy of contents. The watermarking apparatus includes: a watermark generating unit that divides the digital image into a plurality of regions, assigns predetermined secret keys to each of the divided regions, respectively, and generates a watermark for each of the divided regions using the corresponding secret key; and a watermark embedding unit that generates a watermarked image for the digital image by embedding the watermarks in the corresponding regions, respectively, and combines the watermark-embedded divided regions. Since different kinds of keys are used when watermarking and extracting watermarked information, the watermark can be protected from illegal attacks.

This application claims the benefit of Korean Patent Application No. 10-2004-0006595, filed on Feb. 2, 2004, in the Korean Intellectual Property Office, the disclosure of which is incorporated herein in its entirety by reference.

### BACKGROUND OF THE INVENTION

1. Field of the Invention

The present invention relates to digital image watermarking for copyright protection of digital image contents, and more particularly, to apparatuses and methods for generating a watermarked image by dividing an original image into a plurality of regions, assigning a predetermined secret key to each of the regions, and extracting watermark information from the watermarked image using a public key comprising secret keys.

2. Description of the Related Art

Digital contents, unlike analog contents, can be duplicated infinitely without information loss. The recent development of the Internet has increased unauthorized use of digital contents such as illegal duplication or distribution. Thus, digital watermarking techniques have been suggested to prevent illegal distribution of digital contents.

Digital watermarking is a technique of embedding copyright information such as information on a copyright proprietor or distributor of digital contents as a watermark that cannot be perceived by a human being so as to identify and protect a legal copyright owner in a possible future dispute on the copyright of digital contents. Information that can be embedded as a watermark in digital contents includes copyright information, useful information provided only to legal purchasers, contents keys used for decoding the digital contents, etc. Hereinafter, these kinds of information that can be embedded as a watermark in digital contents will be collectively referred to as watermark information. In watermarking, transparency of a watermark to the human eyes, robustness to various modifications of digital contents, security against deliberate attacks, etc., should be considered.

According to conventional digital watermarking, a watermark embedded in digital contents is available to identify only the copyright of the contents. In other words, when watermarked digital contents are illegally duplicated and distributed, the lawful copyright owner of the contents can be identified but it is impossible to find out who is responsible for the illegal distribution.

To solve this problem, a fingerprinting technique has been introduced. Fingerprinting is a technique of embedding personal information about a purchaser of digital contents in the digital contents as a fingerprint. This allows an identification of an illegal distributor of the digital contents using the fingerprint extracted from illegally distributed digital contents in order to take proper legal action against the illegal use of digital contents.

However, in the conventional watermarking method, an identical secret key is used when generating and extracting watermarks. Therefore, when the inner information of an extractor is disclosed due to an attack on the extractor, the security of a whole system is threatened because the disclosed information is identical with information of an embedder. Further, conventional fingerprinting intrinsically requires a large-scale encryption algorithm and thus involves a complicated key generating process.

### SUMMARY OF THE INVENTION

The present invention provides, as an effective defensive measure against attacks on watermarks, a method and apparatus for generating a watermarked image by dividing an original digital image into a plurality of regions and assigning a secret key to each of the regions and a method and apparatus for extracting watermark information from the watermarked image only using a public key comprising secret keys.

The present invention also provides simple, effective fingerprinting including generating a plurality of watermarked images from an original image by assigning a secret key combination in a unique order to each divided region of the original image.

In an aspect of the present invention, there is provided a watermarking apparatus for embedding a watermark in a digital image, the apparatus comprising: a watermark generating unit dividing the digital image into a plurality of regions, assigning a predetermined secret key to each of the divided regions, and generating a watermark for each of the divided regions using the corresponding secret key; and a watermark embedding unit generating a watermarked image for the digital image by embedding the watermarks in the corresponding regions, respectively, and combining the watermark-embedded divided regions.

The watermark generating unit may comprises: a dividing portion dividing the digital image into the plurality of regions; a secret key generating portion generating different secret keys; a secret key assigning portion assigning the secret keys to the divided regions, respectively; and a watermark generating portion generating the watermark for each of the regions using the corresponding secret key.

The watermark generating unit may assign a unique secret key to each of the divided regions. The secret keys may be pseudonoise (PN) sequences generated using a spread spectrum watermarking algorithm. The secret keys may be orthonormal to and independent from each other and images of the divided regions.

The watermark embedding unit may generate a plurality of different watermarked images by assigning a combination of secret keys in a unique order for each of the watermarked images. In this case, the watermark generating unit may generate a number of secret keys equal to the number of the divided regions and assigns a number of combinations of the secret keys equal to the factorial of the number of divided regions to generate the watermark for each of the regions. The watermark generating unit may divide the digital image into m regions, generates n secret keys, and assigns n^{m} combinations of the secret keys to the divided regions, respectively.

In another aspect of the present invention, there is provided a method of embedding a watermark in a digital image, the method comprising: dividing the digital image into a plurality of regions; generating a plurality of different secret keys; assigning the plurality of secret keys to the divided regions, respectively; generating a watermark for each of the regions using the corresponding secret key; embedding the watermarks in the corresponding regions, respectively; and generating a watermarked image for the digital image by combining the watermark-embedded divided regions.

In the above-described method, the secret keys may be orthonormal to and independent from each other and images of the divided regions. In the assigning of the plurality of secret keys, a unique secret key may be assigned to each of the divided regions. The secret keys may be PN sequences generated using a spread spectrum watermarking algorithm.

In the generating of the watermarked image, a plurality of watermarked images may be generated, and in the assigning of the plurality of secret keys, a combination of secret keys in a unique order may be assigned for each of the watermarked images. In the generating of the plurality of secret keys, a number of secret keys equal to the number of the divided regions may be generated, and the maximum number of secret key combinations that can be assigned to the divided regions may be equal to the factorial of the number of divided regions. In the dividing of the digital image into the plurality of regions, the digital image may be divided into m regions, in the generating the secret keys, n secret keys are generated, and in the assigning of the secret keys, the maximum number of combinations of secret keys assigned to the divided regions may be equal to n^{m}.

In another aspect of the present invention, there is provided an apparatus for extracting watermark information from a watermarked digital image, the apparatus comprising: a public key providing unit providing a public key comprising secret keys that are assigned to divided regions of an original digital image, respectively, wherein each divided region is watermarked using the corresponding secret key; and a watermark information extracting unit extracting watermark information from the watermarked digital image using the public key.

In the above-described apparatus, the public key may have a value that is equal to the sum of the secret keys. The secret keys may be orthonormal to and independent from each other and images of the divided regions. The watermark information extracting unit may extract the watermark information based on the inner product of the public key and the watermarked digital image.

In another aspect of the present invention, there is provided an apparatus for identifying whether a watermarked image is a copy of contents, the apparatus comprising: a dividing unit dividing the arbitrary watermarked image into a plurality of regions, the arbitrary watermarked image being generated by embedding watermarks generated by assigning combinations of secret keys for individual divided regions of an original digital image in different orders to copies of contents, respectively; a secret key operating unit performing an operation on each of the divided regions using each of the combinations of secret keys assigned to copies of the contents in the arbitrary watermarked image; and a copy of contents identifying unit identifying whether the arbitrary watermarked image is a copy of contents based on the results of the operations in the secret key operating unit.

The copy of contents identifying apparatus may further comprise a contents identifying unit identifying contents in the arbitrary watermarked image. When the arbitrary watermarked image is expressed as Yᵢ=(X₁+α·b·pᵢ₁)+(X₂+α·b·pᵢ₂)+ . . . +(Xₙ+α·b·pᵢₙ), the secret key operating unit may perform an operation according to the following equation, and the copy of contents identifying unit may identify the arbitrary watermarked image as an i-th copy of contents when the result of the operation in the secret key operating unit is equal to n×b where n is the number of the divided regions:
(X₁+α·b·pᵢ₁)·pⱼ₁+(X₂+α·b·pᵢ₂)·pⱼ₂+ . . . +(Xₙ+α·b·pᵢₙ)·pⱼₙ

where X₁, X₂, . . . , Xₙ denote images of the divided regions of the digital image, b denotes watermark information embedded in the digital image, α is a constant for controlling the size of the watermark information so as not to be unpleasant to the human eyes, pᵢ₁, pᵢ₂, . . . , pᵢₙ denote the combinations of secret keys assigned to the divided regions of the watermarked image Yᵢ, and pⱼ₁, pⱼ₂, . . . , pⱼₙ denote the combinations of secret keys assigned to a plurality of watermarked images, wherein the secret keys are orthonormal to and independent from each other and images of the divided regions.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a watermarking system;

FIG. 2 is a block diagram of a watermarking apparatus according to an exemplary embodiment of the present invention;

FIG. 3 illustrates an example of a structure of a secret key assignment information database (DB) of FIG. 2;

FIG. 4 is a table of the combinations of watermarks for individual regions that are assigned to copies of contents, respectively;

FIG. 5 is a table of watermarked images to be assigned to individual copies of contents;

FIG. 6 is a flowchart illustrating a watermarking method according to an exemplary embodiment of the present invention;

FIG. 7 is a block diagram of a watermark information extracting apparatus according to another aspect of an exemplary embodiment of the present invention;

FIG. 8 is a diagram for explaining a process of extracting watermark information in the watermark information extracting apparatus of FIG. 7;

FIG. 9 is a block diagram of an apparatus for identifying a copy of contents according to another aspect of an exemplary embodiment the present invention;

FIG. 10 is a table for explaining a process of identifying a copy of contents in a watermarked image in the apparatus of FIG. 9; and

FIG. 11 is a flowchart illustrating a method of identifying a copy of contents according to another aspect of an exemplary embodiment of the present invention.

### DETAILED DESCRIPTION OF THE EXEMPLARY EMBODIMENT

Embodiments of the present invention now will be described in detail with reference to the accompanying drawings.

In general, digital watermarking involves three operations, i.e., generating, embedding, and detecting watermarks.

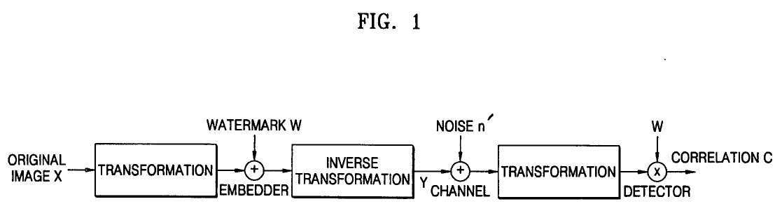

FIG. 1 illustrates a general digital watermarking system that generates a watermarked digital image by embedding a watermark image in an original digital image and restores the watermark image from the watermarked digital image.

In general, watermarking is based on a spread spectrum watermarking algorithm that is highly concealable and uses pseudonoise (PN) signals as secret keys to generate watermarks, which are orthonormal and independent to one another. Being independent and orthonormal implies that the inner product of equivalent vectors has a significant value of, for example, 1, and the inner product of different vectors has an insignificant value of, for example, 0.

According to Equation 1 below, a watermark W generated using the spread spectrum watermarking algorithm is embedded in an original image X to output a watermarked image Y.
Y=X+αW (1)

where α is a constant for controlling the size of the embedded watermark so as not to be unpleasant to the human eyes. The watermark can be directly added to a spatial domain of the original image. However, embedding the watermark in the original image after transformation such as discrete cosine transformation (DCT), discrete Fourier transformation (DFT), fast Fourier transform (FFT), discrete wavelet transform (DWT), etc., as illustrated in FIG. 1, is common and more robust to general signal processing and signal distortion. In this case, the original image in which the watermark has been embedded is inversely transformed and output as the watermarked image Y.

While the watermarked image Y is transmitted, a channel noise n′ is added to the watermarked image Y and the watermarked image Y is transformed by the same method as used when embedding the watermark. In a detector, a correlation value c is detected using the same watermark W as generated in an embedder. If the correlation value is greater than a reference value, it is determined that a watermark is embedded in the restored image. Otherwise, it is determined that no watermark is embedded in the restored image.

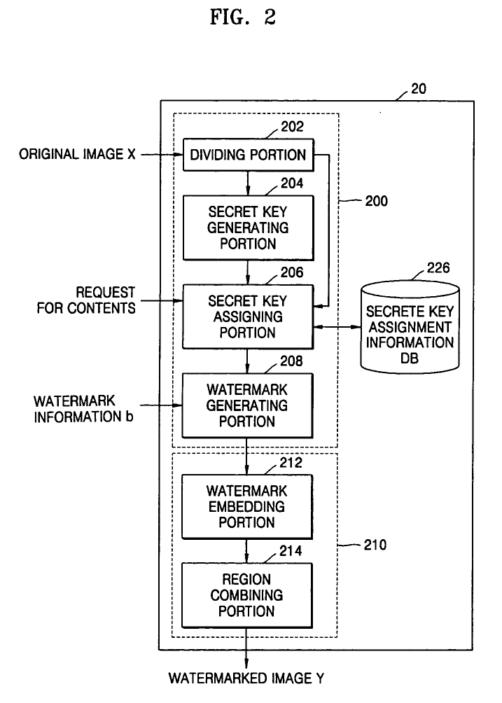

FIG. 2 is a block diagram of a watermarking apparatus according to an exemplary embodiment of the present invention. Referring to FIG. 2, a watermarking apparatus 20 includes a dividing portion 202, which divides an input original image X into n regions (n=2, 3, 4 . . . ), a secret key generating portion 204, which generates n different secrete keys, a secret key assigning portion 206, which assigns n secret keys to n divided regions, respectively, a watermark generating portion 208, which generates a watermark for each of the regions using a corresponding secret key assigned to the region based on information b regarding a watermark to be embedded in the original image, a watermark embedding portion 212, which embeds each of the watermarks in a corresponding region, a region combining portion 214, which generates a watermarked image Y for the original image X by combining the regions in which the watermarks are embedded. The dividing portion 202, the secret key generating portion 204, the secret key assigning portion 206, and the watermark generating portion 208 constitute a watermark generating unit 200. The watermark embedding portion 212 and the region combining portion 214 constitute a watermark embedding unit 210.

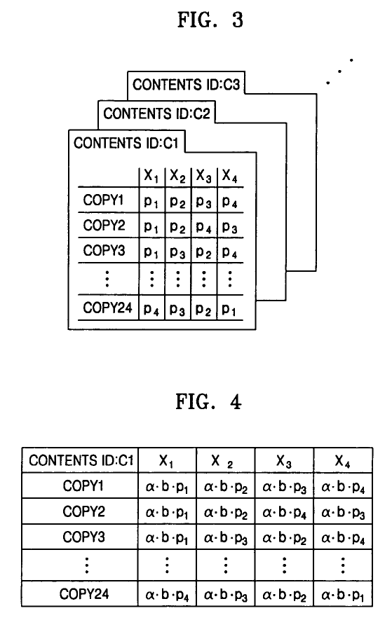

In an exemplary embodiment of the present invention, to implement fingerprinting, the secret key assigning portion 206 assigns n!(=n×(n−1)×(n−2)×(n−3)× . . . ×2×1) secret key combinations, each comprising secret keys for n divided regions combined in a unique order, to copies of contents, respectively, and stores secret key assignment information in the secret key assignment information DB 226. FIG. 3 illustrates an exemplary configuration of the secret key assignment information DB 226 storing information regarding the assignment of 24 (=4!) combinations of four secret keys p₁, p₂, p₃, p₄ for four divided regions X₁, X₂, X₃, X₄ of an original image X of a digital image contents (ID No. C1) to 24 copies of contents, respectively.

However, when there is no need to implement fingerprinting and it is allowed to embed the same watermark information in all contents, the secret key assigning portion 206 may simply assign n secret keys to the divided regions and the secret key assignment information DB 226 is not needed.

The dividing portion 202 divides the original image X into n regions so as to provide n!(=n×(n−1)×(n−2)×(n−3)× . . . ×2×1) copies of contents with different secret key combinations. The different secret key combinations refer to sets of secret keys for the divided regions combined in different orders. The watermarking apparatus 20 can receive contents IDs together with the original image Z via an input unit (not shown).

The secret key generating portion 204 generates n different secret keys. As described above, the secret keys should be orthonormal to and independent from each other and images of the divided regions. When an authorized contents purchaser has a right to the watermark information b embedded in the original image X, the contents purchaser can be provided with a public key generated by combining the secret keys to be able to extract the watermark information embedded in the original image using the public key, which will be described below.

Because only the public key, not individual secret keys, is provided to the purchaser when requested, even if the public key formed as a combination of n secret keys is disclosed, it is very difficult to identify all the secret keys based on the public key. Furthermore, considering that a general key size is of 128 bits, it is practically impossible to find secret keys constituting a public key only based on the public key.

Secret keys can be generated using a general key generating algorithm. For example, a pseudo noise (PN) sequence, which is randomly generated for an arbitrary key according to a spread spectrum watermarking algorithm, can be used as a secret key. The PN sequence consists of as many bits as for the watermark information b.

The secret key assigning portion 206 generates n! secret key combinations by assigning n secret keys to n divided regions for each content and stores the secret key combinations in the secret key assignment information DB 226. Therefore, when there are a maximum number of n! copies of contents to be distributed, a user who is responsible for illegal distribution that is likely to occur in the future can be identified by assigning n! secret key combinations to each copy of contents. For example, when the watermarking apparatus 20 provides contents to purchasers in a wideband network such as the Internet, the watermarking apparatus 20 can manage a separate purchaser information DB storing user's personal information, which is registered by users, so as to identify a user who is responsible for future illegal distribution of copies of contents. When there is no need to prohibit illegal coping and distribution of contents and assign a unique secret key combination to each copy of contents, it is enough to assign only one secret key combination to each contents.

When a request for particular contents is externally input, the secret key assigning portion 206 extracts one secret key combination from a table corresponding to the ID of the particular contents in the secret key assignment information DB 226 and transmits the secret key combination to the watermark generating portion 208. When the watermarking apparatus 20 is used in connection with purchaser's terminals via a wideband communication network such as the Internet, the water marking apparatus 20 may receive the request for contents from a purchaser via a communication unit (not shown). When the watermarking apparatus 20 is used to embed a watermark in an original image written in a recording medium such as a DVD, the request for contents can be a command for a watermark to be embedded in particular contents that is input via an input unit by a copyright proprietor or distributor of the contents.

The watermark generating portion 208 generates watermarks for the divided regions that a copyright proprietor or distributor of contents wants to embed in a particular contents according to the watermark information b, based on the secret key combinations transmitted from the secret key assigning portion 206. Alternatively, the watermark generating portion 208 may generate watermarks for the divided regions with reference to the secret key assignment information DB 226. FIG. 4 is a table of watermarks for the divided regions that are generated based on the secret key combinations assigned to the 24 copies of the contents having an ID of C1 in FIG. 3. As described above, α in FIG. 4 is a constant for controlling the size of an embedded watermark not to be unpleasant to the human eyes. Since a unique secret key is assigned to each of the divided regions, α for each of the divided regions can be slightly varied.

The watermark embedding portion 212 embeds each of the watermarks in an image of a corresponding divided region. The watermarks can be directly added to a spatial domain of the original image. However, embedding the watermarks in the original image after transformation such as discrete cosine transformation (DCT), discrete Fourier transformation (DFT), fast Fourier transform (FFT), discrete wavelet transform (DWT), etc., as illustrated in FIG. 1, is common and more robust to general signal processing and signal distortion. In this case, the original image in which the watermarks have been embedded is inversely transformed and output as a watermarked image.

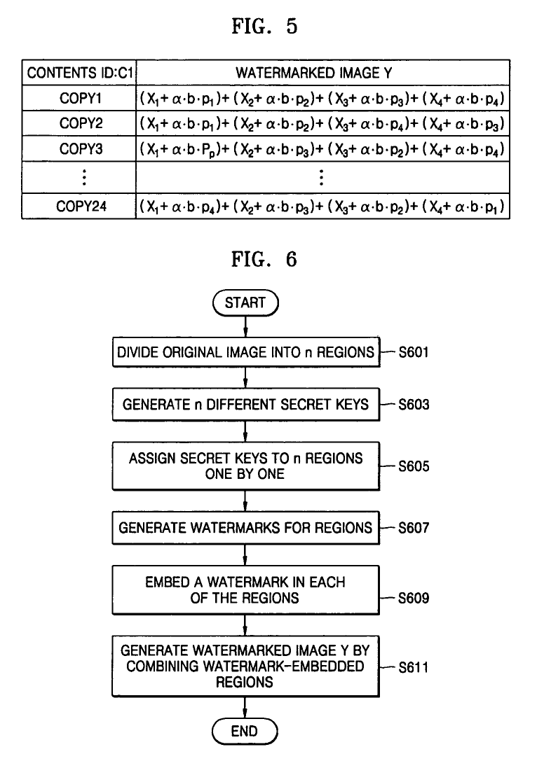

The region combining portion 214 combines the watermark-embedded divided regions and finally outputs a watermarked image Y for the original image X. FIG. 5 is a table of watermarked images for 24 copies of contents when the original image X is divided into 4 regions. The watermarked images for the copies of contents actually differ from one another but seem to be identical because the differences are too small to be perceived by a human being.

FIG. 6 is a flowchart of a watermarking method according to an exemplary embodiment of the present invention. Referring to FIG. 6, the watermarking method includes dividing an input original image X into n regions (S601), generating n different secret keys (S603), assigning n secret keys to n divided regions, respectively (S605), generating a watermark for each of the divided regions using a secret key assigned to the corresponding divided region (S607), embedding a corresponding watermark in each of the divided regions (S609), and generating a watermarked image Y for the original image X by combining the watermark-embedded divided regions (S611).

Although in the method illustrated in FIG. 6 an identical secret key combination is assigned to all copies of contents, a unique secret key combination can be assigned to each of the copies of contents so as to seek out in the future a person who is responsible for illegal duplication. In this case, the method may further include assigning a unique secret key combination to each of the copies of contents between operations S605 and S607.

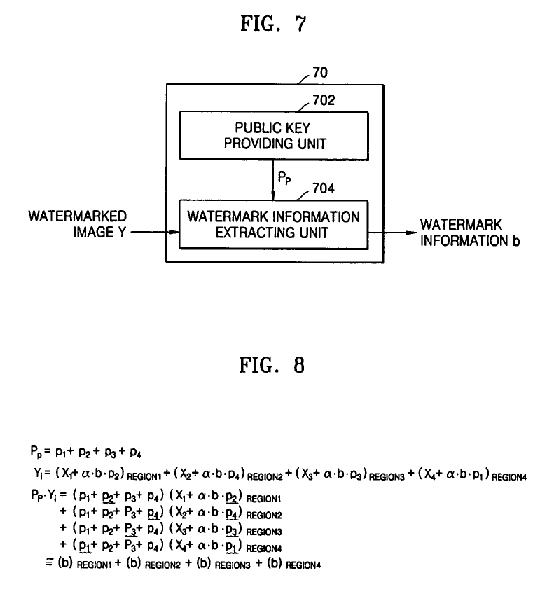

FIG. 7 is a block diagram of a watermark information extracting apparatus 70 for extracting watermark information from a watermarked image Y using a public key provided together with a copy of contents in a digital image watermarked by the watermarking apparatus of FIG. 2. Although only a structure of the watermark information extracting apparatus 70 is described below for the convenience of explanation, a method of extracting watermark information using the watermark information extracting apparatus 70 also lies within the scope of the invention.

A public key providing unit 702 provides a public key to a watermark information extracting unit 704. The public key consists of secret keys assigned to individual divided regions of the watermarked image Y and is actually a value that is equal to the sum of the secret keys. That is, the public key is expressed as Pₚ=p₁+p₂+ . . . +pₙ. When the watermark information extracting apparatus 70 is a computer of a copy of contents purchaser, the public key providing unit 702 can obtain a public key by receiving a public key input from an input unit of the purchaser's computer or by extracting a public key included in the purchased copy of contents. When the watermark information extracting apparatus 70 is provided with a copy of contents via a wideband network such as the Internet, the public key providing unit 702 can receive a public key together with the copy of contents from a copy of contents providing server.

The watermark information extracting unit 704 extracts the watermark information b from the watermarked image Y using the public key transmitted from the public key providing unit 702. FIG. 8 is for explaining a process of decoding an i-th digital image Yᵢ provided to a purchaser using a public key Pₚ. In the method of FIG. 8, since secret keys are orthonormal to and independent from each other and images of divided regions, watermark information b regarding each of the regions can be extracted by multiplying the digital image Yᵢ by the public key Pₚ.

When a copyright proprietor or distributor of a copy of contents is allowed to determine whether use of the copy of contents is illegal, the watermark information extracting apparatus 70 can be included in or operated in synchronization with, for example, the watermarking apparatus 20 of FIG. 2 at a copy of contents provider site. Therefore, when extracting of watermark information from a watermarked image using the method of FIG. 8 fails, the watermarked image is determined to be illegal.

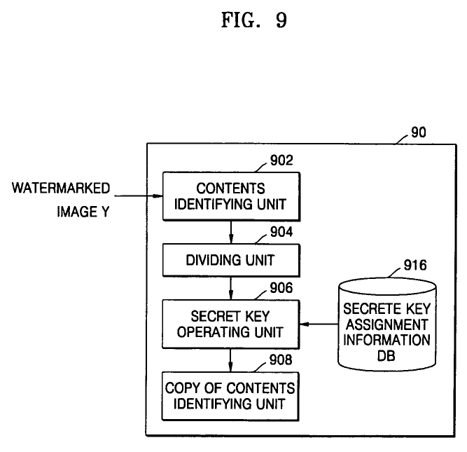

FIG. 9 is a block diagram of a copy of contents identifying apparatus 90 for identifying a copy of contents in a digital image watermarked by the watermarking apparatus 20 of FIG. 2. A contents identifying unit 902 identifies contents in an input watermarked image Y. The contents in the watermarked image may include an identifier that discriminates the contents from other contents to allow the contents identifying unit 902 to identify the contents based on the identifier. However, when there is no need to identify what the contents are because they are already identified, a code of the contents can be input using an inputting unit. In this case, the contents identifying unit 902 is not needed.

A dividing unit 904 divides the watermarked image Y formed by combining n watermark-embedded regions into n regions, transmits the n regions to a secret key operating unit 906.

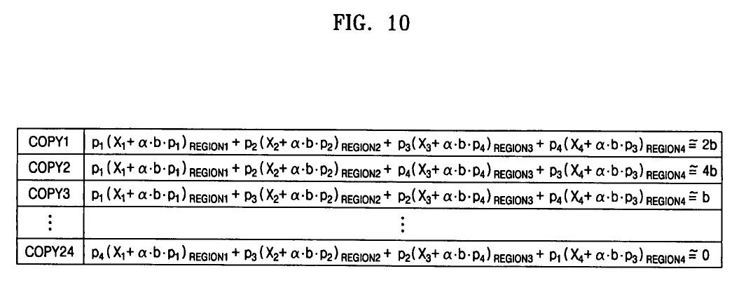

The secret key operating unit 906 extracts secret keys from a corresponding table of contents in a secret key assignment information DB 916 and performs an operation using the secret keys for each of the corresponding copies of contents as illustrated in FIG. 10. In general, when an arbitrary watermarked image is expressed as Yᵢ=(X₁+α·b·pᵢ₁)+(X₂+α·b·pᵢ₂)+ . . . +(Xₙ+α·b·pᵢₙ) , the secret key operating unit 906 performs an operation according to Equation 2 below.
(X₁+α·b·pᵢ₁) ·pⱼ₁+(X₂+α·b·pᵢ₂)·pⱼ₂+ . . . +(Xₙ+α·b·pᵢₙ)·pⱼₙ (2)

where X₁, X₂, . . . , Xₙ denote images of the divided regions of the digital image, b denotes watermark information embedded in the digital image, α is a constant for controlling the size of the watermark information so as not to be unpleasant to the human eyes, pᵢ₁, pᵢ₂, . . . , pᵢₙ denote secret key combinations assigned to the divided regions X₁, X₂ . . . of the watermarked image Yᵢ, and pⱼ₁, pⱼ₂ . . . , pⱼₙ denote secret key combinations assigned to a plurality of watermarked images X₁+α·b·pⱼ₁, X₂+α·b·pᵢ₂, . . . As described above, the secret keys are orthonormal to and independent from each other and images of the divided regions.

The secret key assignment information DB 916 can have the same configuration as illustrated in FIG. 3. Alternatively, the copy of contents identifying apparatus 90 can share the secret key assignment DB 226 when included in or operated in synchronization with the watermarking apparatus 20 of FIG. 2. The copy of contents identifying unit 908 identifies COPY 2, which has a value equal to the product of (the number of divided parts) ×b, i.e., 4×b, as a result of the operation using secret keys, as a copy of contents in the watermarked image Y.

In other words, since the secret keys are orthonormal to and independent from each other and the images of the divided regions, the results of operations according to FIG. 10 using secret key combinations assigned to copies of contents in the watermarked image Y are always equal to the product of (the number of divided regions)×b. Based on this, a copy of contents or a purchaser of the contents can be easily identified.

Therefore, when a purchaser of contents in the watermarked image distributes illegal duplications of the contents in the market, a copyright proprietor or distributor of the contents can easily find out the purchaser of the contents who has illegally distributed the copies of the contents.

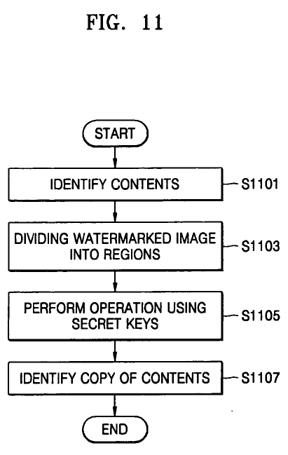

FIG. 11 is a flowchart illustrating a method of identifying a copy of contents in a watermarked image. Referring to FIG. 11, the copy of contents identifying method includes identifying contents in an input watermarked image (S1101), dividing the watermarked image into a plurality of regions in the same manner as in the watermarking process (S1103), performing an operation according to FIG. 10 using each of the secret key combinations assigned to the contents (S1105), and identifying a copy of contents that has a value equal to the product of (the number of divided regions)×b as a result of the operation as a copy of the contents of the watermarked image.

As described above, according to an exemplary embodiment of the present invention, a digital image is divided into a plurality of regions, and a public key generated by combining as many secret keys as the divided regions of the digital image is provided to a purchaser to allow the purchaser to extract watermark information embedded in the digital image only using the public key. Therefore, even if the public key is disclosed, the secret keys assigned to the individual divided regions cannot be identified so that malicious manipulation such as deleting or modifying watermark information such as copyright information regarding the watermarked image can be prevented.

Although in the embodiments described above as many secret keys as divided regions are generated and a unique secret key is assigned to each of the divided regions to implement the present invention, the number of secret keys to be generated can be determined regardless of the number of divided regions provided that at least one divided region has a secret key that differ from a secret key assigned to another divided region. For example, when the number of divided regions is m (=2, 3, 4, . . . ) and the number of secret keys is n (=2, 3, 4, . . . ), n^{m} purchasers can be identified.

For example, when an original image X is divided into three regions, and two secret keys are generated and assigned to the divided regions, 8 (=2³) purchasers can be identified. In this case, unlike the case where as many secret keys as divided regions are generated and assigned to the divided regions, respectively, each of the purchasers can have a unique public key. However, watermark information can be extracted from the watermarked image provided to a purchaser only using the public key. In particular, since secret keys for the individual divided regions that are combined in a unique order are assigned to each copy of contents, a purchaser who is responsible for illegal distribution of the copy can be easily found.

When only a public key is available to decode a watermarked image provided to a purchaser, there is a need to control α for each of the divided regions of the watermarked image. In this case, a value of α for divided regions to which an identical secret key is assigned is divided by the number of identical secret keys. In particular, when a purchaser is provided with a public key expressed as p₁+p₂+p₂ and a watermarked image expressed as

Y=(X_{1+α}1′·b·p₁)+(X₂+α2′·b·p₁)+(X₃+α3·b·p₂), α1′ and α2′ are determined to be half of α1′ and α2′, respectively, which result in watermarks being small enough so as not to be unpleasant to the human eyes. Therefore, the watermarked image can be decoded only using the public key according to the method of FIG. 8.

The watermarking method, the watermark information extracting method, and the copy of contents identifying method described in the embodiments according to the present invention can be implemented as programs recorded in computer readable media, including but not limited to magnetic storage, optically readable media, and carrier waves (e.g., transmissions over the Internet).

As described above, according to the present invention, a digital image in which watermark information is to be embedded is divided into a plurality of regions, and a watermark is generated for each of the regions by assigning a secret key to each of the regions. When decoding a watermarked image, only a public key comprising the secret keys is available to extract the watermark information from the watermarked image. Therefore, illegal attacks on the watermark embedded in the digital image can be effectively blocked.

In addition, by assigning different combinations of secret keys for the divided regions of the digital image to copies of contents, respectively, more secure fingerprinting can be easily implemented compared to conventional fingerprinting.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A watermarking apparatus for embedding a watermark in a digital image, the apparatus comprising:
a watermark generating unit that divides the digital image into a plurality of regions, assigns predetermined secret keys to each of the divided regions, respectively, and generates a watermark for each of the divided regions using the corresponding secret key; and
a watermark embedding unit that generates a watermarked image for the digital image by embedding the watermarks in the corresponding regions, respectively, and combines the watermark-embedded divided regions.

2. The apparatus of claim 1, wherein the watermark generating unit comprises:
a dividing portion that divides the digital image into the plurality of regions;
a secret key generating portion that generates different secret keys;
a secret key assigning portion that assigns the secret keys to the divided regions, respectively; and
a watermark generating portion that generates the watermark for each of the regions using the corresponding secret key.

3. The apparatus of claim 1, wherein the watermark generating unit assigns a unique secret key to each of the divided regions.

4. The apparatus of claim 1, wherein the secret keys are pseudonoise sequences generated using a spread spectrum watermarking algorithm.

5. The apparatus of claim 1, wherein the secret keys are orthonormal to and independent from each other and images of the divided regions.

6. The apparatus of claim 1, wherein the watermark embedding unit generates a plurality of different watermarked images by assigning a combination of secret keys in a unique order for each of the watermarked images.

7. The apparatus of claim 6, wherein the watermark generating unit generates a number of secret keys equal to the number of the divided regions and assigns a number of combinations of the secret keys equal to the factorial of the number of divided regions to generate the watermark for each of the regions.

8. The apparatus of claim 6, wherein the watermark generating unit divides the digital image into m regions, generates n secret keys, and assigns n^{m} combinations of the secret keys to the divided regions, respectively.

9. A method of embedding a watermark in a digital image, the method comprising:
dividing the digital image into a plurality of regions;
generating a plurality of different secret keys;
assigning the plurality of secret keys to the divided regions, respectively;
generating a watermark for each of the regions using the corresponding secret key;
embedding the watermarks in the corresponding regions, respectively; and
generating a watermarked image for the digital image by combining the watermark-embedded divided regions.

10. The method of claim 9, wherein the secret keys are orthonormal to and independent from each other and images of the divided regions.

11. The method of claim 9, wherein, in the assigning of the plurality of secret keys, a unique secret key is assigned to each of the divided regions.

12. The method of claim 9, wherein the secret keys are pseudonoise sequences generated using a spread spectrum watermarking algorithm.

13. The method of claim 9, wherein, in the generating of the watermarked image, a plurality of watermarked images are generated, and in the assigning of the plurality of secret keys, a combination of secret keys in a unique order is assigned for each of the watermarked images.

14. The method of claim 13, wherein, in the generating of the plurality of secret keys, a number of secret keys equal to the number of the divided regions are generated, and the maximum number of secret key combinations that can be assigned to the divided regions is equal to the factorial of the number of divided regions.

15. The method of claim 13, wherein, in the dividing of the digital image into the plurality of regions, the digital image is divided into m regions, in the generating the secret keys, n secret keys are generated, and in the assigning of the secret keys, the maximum number of combinations of secret keys assigned to the divided regions is equal to n^{m}.

16. A computer readable medium having embodied thereon a computer program for a watermarking method of embedding a watermark in a digital image, the method comprising:
dividing the digital image into a plurality of regions;
generating a plurality of different secret keys;
assigning the plurality of secret keys to the divided regions, respectively;
generating a watermark for each of the regions using the corresponding secret key;
embedding the watermarks in the corresponding regions, respectively; and
generating a watermarked image for the digital image by combining the watermark-embedded divided regions.

17. The computer readable medium of claim 16, wherein the secret keys are orthonormal to and independent from each other and images of the divided regions.

18. The computer readable medium of claim 16, wherein, in the assigning of the plurality of secret keys, a unique secret key is assigned to each of the divided regions.

19. An apparatus for extracting watermark information from a watermarked digital image, the apparatus comprising:
a public key providing unit providing a public key comprising secret keys that are assigned to divided regions of an original digital image, respectively, wherein each divided region is watermarked using the corresponding secret key; and
a watermark information extracting unit extracting watermark information from the watermarked digital image using the public key.

20. The apparatus of claim 19, wherein the public key has a value that is equal to the sum of the secret keys.

21. The apparatus of claim 20, wherein the secret keys are orthonormal to and independent from each other and images of the divided regions.

22. The apparatus of claim 21, wherein the watermark information extracting unit extracts the watermark information based on the inner product of the public key and the watermarked digital image.

23. A method of extracting watermark information from a watermarked digital image, the method comprising:
providing a public key comprising secret keys that are assigned to divided regions of an original digital image, respectively, wherein each divided region is watermarked using the corresponding secret key; and
extracting watermark information from the watermarked digital image using the public key.

24. The method of claim 23, wherein the public key has a value that is equal to the sum of the secret keys.

25. The method of claim 24, wherein the secret keys are orthonormal to and independent from each other and images of the divided regions.

26. The method of claim 25, wherein the extracting of the watermark information is performed based on the inner product of the public key and the watermarked digital image

27. A computer readable medium having embodied thereon a computer program for a method of extracting watermark information from a watermarked digital image, the method comprising:
providing a public key comprising secret keys that are assigned to divided regions of an original digital image, respectively, wherein each divided region is watermarked using the corresponding secret key; and
extracting watermark information from the watermarked digital image using the public key.

28. An apparatus for identifying whether a watermarked image is a copy of contents, the apparatus comprising:
a dividing unit that divides the arbitrary watermarked image into a plurality of regions, the arbitrary watermarked image being generated by embedding watermarks generated by assigning combinations of secret keys for individual divided regions of an original digital image in different orders to copies of contents, respectively;
a secret key operating unit that performs an operation on each of the divided regions using each of the combinations of secret keys assigned to copies of the contents in the arbitrary watermarked image; and
a copy of contents identifying unit that identifies whether the arbitrary watermarked image is a copy of contents based on the results of the operations in the secret key operating unit.

29. The apparatus of claim 28 further comprising a contents identifying unit identifying contents in the arbitrary watermarked image.

30. The apparatus of claim 28, wherein, when the arbitrary watermarked image is expressed as Yᵢ=(X₁+α·b·pᵢ₁)+(X₂+α·b·pᵢ₂)+ . . . +(Xₙ+α·b·pᵢₙ), the secret key operating unit performs an operation according to the following equation, and the copy of contents identifying unit identifies the arbitrary watermarked image as an i-th copy of contents when the result of the operation in the secret key operating unit is equal to n×b where n is the number of the divided regions:
(X₁+α·b·pᵢ₁)·pⱼ₁+(X₂+α·b·pᵢ₂)·pⱼ₂+ . . . +(Xₙ+α·b·pᵢₙ)·pⱼₙ
where X₁, X₂, . . . , Xₙ denote images of the divided regions of the digital image, b denotes watermark information embedded in the digital image, α is a constant for controlling the size of the watermark information so as not to be unpleasant to the human eyes, pᵢ₁, pᵢ₂, . . . , pᵢₙ denote the combinations of secret keys assigned to the divided regions of the watermarked image Yᵢ, and pⱼ₁, pⱼ₂, . . . , pⱼₙ denote the combinations of secret keys assigned to a plurality of watermarked images, wherein the secret keys are orthonormal to and independent from each other and images of the divided regions.

31. A method of identifying whether a watermarked image is a copy of contents, the method comprising:
dividing the arbitrary watermarked image into a plurality of regions, the arbitrary watermarked image being generated by embedding watermarks generated by assigning combinations of secret keys for individual divided regions of an original digital image in different orders to copies of contents, respectively;
performing an operation on each of the divided regions using each of the combinations of secret keys assigned to copies of the contents in the arbitrary watermarked image; and
identifying whether the arbitrary watermarked image is a copy of contents based on the results of the operations using the combinations of secret keys.

32. The method of claim 31, wherein the dividing of the arbitrary watermarked image comprises identifying contents in the arbitrary watermarked image.

33. The method of claim 31, wherein, when the arbitrary watermarked image is expressed as Yᵢ=(X₁+α·b·pᵢ₁)+(X₂+α·b·pᵢ₂)+ . . . +(Xₙ+α·b·pᵢₙ), the operation on each of the divided regions using each of the combination of secret keys is performed according to the following equation, and in the identifying of the arbitrary watermarked image, the arbitrary watermarked image is identified as an i-th copy of contents when the result of the operation is equal to n×b where n is the number of the divided regions:
(X₁+α·b·pᵢ₁)·pⱼ₁+(X₂+α·b·pᵢ₂)·pⱼ₂+ . . . +(Xₙ+α·b·pᵢₙ)·pⱼₙ
where X₁, X₂, . . . , Xₙ denote images of the divided regions of the digital image, b denotes watermark information embedded in the digital image, α is a constant for controlling the size of the watermark information so as not to be unpleasant to the human eyes, pᵢ₁, pᵢ₂, . . . , pᵢₙ denote the combinations of secret keys assigned to the divided regions of the watermarked image Yᵢ, and pⱼ₁, pⱼ₂, . . . , pⱼₙ denote the combinations of secret keys assigned to a plurality of watermarked images, wherein the secret keys are orthonormal to and independent from each other and images of the divided regions.

34. A computer readable medium having embodied thereon a computer program for a method of identifying whether an arbitrary watermarked image is a copy of contents, the method comprising:
dividing the arbitrary watermarked image into a plurality of regions, the arbitrary watermarked image being generated by embedding watermarks generated by assigning combinations of secret keys for individual divided regions of an original digital image in different orders to copies of contents, respectively;
with the assumption that the arbitrary watermarked image is expressed as Yᵢ=(X₁+α·b·pᵢ₁)+(X₂+α·b·pᵢ₂)+ . . . +(Xₙ+α·b·pᵢₙ), performing an operation on each of the divided regions using each of the combinations of secret keys assigned to copies of the contents in the arbitrary watermarked image according to the following equation:
(X₁+α·b·pᵢ₁)·pⱼ₁+(X₂+α·b·pᵢ₂)·pⱼ₂+ . . . +(Xₙ+α·b·pᵢₙ)·pⱼₙ
where X₁, X₂, . . . , Xₙ denote images of the divided regions of the digital image, b denotes watermark information embedded in the digital image, α is a constant for controlling the size of the watermark information so as not to be unpleasant to the human eyes, pᵢ₁, pᵢ₂, . . . , pᵢₙ denote the combinations of secret keys assigned to the divided regions of the watermarked image Yᵢ, and pⱼ₁, pⱼ₂, . . . , pⱼₙ denote the combinations of secret keys assigned to a plurality of watermarked images, wherein the secret keys are orthonormal to and independent from each other and images of the divided regions; and
identifying the arbitrary watermarked image as an i-th copy of contents when the result of the operation is equal to n×b where n is the number of the divided regions.
